(19) United States
(12) Patent Application Publication
(10) Pub. No.: US 2017/0124719 A1
(43) Pub. Date: May 4, 2017

(54) METHOD, DEVICE AND COMPUTER-READABLE MEDIUM FOR REGION RECOGNITION

(71) Applicant: Xiaomi Inc., Beijing (CN)

(72) Inventors: Fei LONG, Beijing (CN); Tao ZHANG, Beijing (CN); Zhijun CHEN, Beijing (CN)

(73) Assignee: Xiaomi Inc.

(21) Appl. No.: 15/299,659

(22) Filed: Oct. 21, 2016

(30) Foreign Application Priority Data
Oct. 30, 2015 (CN) 201510727932.0

(51) Int. Cl. G06T 7/00; G06K 9/46; G06K 9/00

(52) U.S. Cl. CPC G06T 7/0081; G06K 9/00456; G06K 9/4604

(57) ABSTRACT

A method for a device to perform region recognition is provided. The method includes: acquiring a recognition model, the recognition model being generated based on a plurality of sample images and a classification algorithm, wherein the sample images includes predefined positive sample images and negative sample images, each of the positive sample images contains at least one numeral character, and each of the negative sample images contains no numeral character or a partial numeral character; identifying at least one numeral region in an image using the recognition model; and performing segmentation on the numeral region to obtain at least one single-numeral region.

### CROSS-REFERENCE TO RELATED APPLICATION

This application is based upon and claims priority to Chinese Patent Application No. 201510727932.0, filed Oct. 30, 2015, the entire contents of which are incorporated herein by reference.

### TECHNICAL FIELD

The present disclosure generally relates to the field of image processing and, more particularly, to a method, a device, and a computer-readable medium for region recognition.

### BACKGROUND

Numeral region recognition involves identifying a numeral region(s) from an image.

In related art, methods for numeral region recognition usually may only recognize a region of numerals with a predetermined size and number of digits in an image. When the numerals of the image have a different font style or font size, or a different number of digits, it may be difficult to recognize the numeral region in the image effectively.

### SUMMARY

According to a first aspect of the present disclosure, there is provided a method for a device to perform region recognition, comprising: acquiring a recognition model, the recognition model being generated based on a plurality of sample images and a classification algorithm, wherein the sample images include predefined positive sample images and negative sample images, each of the positive sample images contains at least one numeral character, and each of the negative sample images contains no numeral character or a partial numeral character; identifying at least one numeral region in an image using the recognition model; and performing segmentation on the numeral region to obtain at least one single-numeral region.

According to a second aspect of the present disclosure, there is provided a device for region recognition, comprising: a processor; and a memory for storing instructions executable by the processor. The processor is configured to: acquire a recognition model, the recognition model being generated based on a plurality of sample images and a classification algorithm, wherein the sample images include predefined positive sample images and negative sample images, each of the positive sample images contains at least one numeral character, and each of the negative sample images contains no numeral character or a partial numeral characters; identify at least one numeral region in an image using the recognition model; and perform segmentation on the numeral region to obtain at least one single-numeral region.

According to a third aspect of the present disclosure, there is provided a non-transitory computer-readable storage medium having stored therein instructions that, when executed by a processor of a device, cause the device to perform a method for region recognition.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for training a recognition model, according to an exemplary embodiment.

FIG. 2 is a flowchart of a method for region recognition, according to an exemplary embodiment.

FIG. 3A is a flowchart of another method for training a recognition model, according to an exemplary embodiment.

FIG. 3B is a schematic diagram illustrating an original sample image, according to an exemplary embodiment.

FIG. 3C is a schematic diagram illustrating a positive sample image, according to an exemplary embodiment.

FIG. 3D is a schematic diagram illustrating a negative sample image, according to an exemplary embodiment.

FIG. 4 is a flowchart of another method for region recognition, according to an exemplary embodiment.

FIG. 5 is a flowchart of another method for region recognition, according to an exemplary embodiment.

FIG. 6A is a flowchart of another method for region recognition, according to an exemplary embodiment.

FIG. 6B is a schematic diagram illustrating a left edge of a merged region, according to an exemplary embodiment.

FIG. 6C is a schematic diagram illustrating a right edge of a merged region, according to an exemplary embodiment.

FIG. 6D is a schematic diagram illustrating a merged region, according to an exemplary embodiment.

FIG. 7A is a flowchart of another method for region recognition, according to an exemplary embodiment.

FIG. 7B is a schematic diagram illustrating a binarized region, according to an exemplary embodiment.

FIG. 7C is a schematic diagram illustrating a histogram of a binarized region, according to an exemplary embodiment.

FIG. 7D is a schematic diagram illustrating sets of consecutive columns of a binarized region, according to an exemplary embodiment.

FIG. 8 is a block diagram of a device for region recognition, according to an exemplary embodiment.

FIG. 9 is a block diagram of another device for region recognition, according to an exemplary embodiment.

FIG. 10 is a block diagram of another device for region recognition, according to an exemplary embodiment.

FIG. 11 is a block diagram of another device for region recognition, according to an exemplary embodiment.

FIG. 12 is a block diagram of a device for training a recognition model, according to an exemplary embodiment.

FIG. 13 is a block diagram of another device for training a recognition model, according to an exemplary embodiment.

FIG. 14 is a block diagram of a device for region recognition, according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of devices and methods consistent with aspects related to the invention as recited in the appended claims.

Consistent with embodiments of the present disclosure, a first procedure of training a recognition model and a second procedure of performing recognition using the recognition model may be used for region recognition in an image. In some implementations, the two procedures may be implemented by a same device. In other implementations, a first device may be configured to perform the first procedure, and a second device may be configured to perform the second procedure.

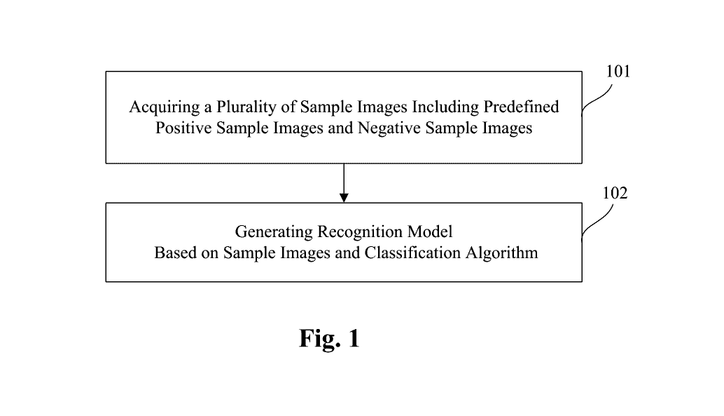

FIG. 1 is a flowchart of a method 100 for training a recognition model, according to an exemplary embodiment. The method 100 may be performed by a device such as a mobile phone, a computer, a digital broadcast terminal, a messaging device, a gaming console, a tablet, a medical device, exercise equipment, a personal digital assistant, and the like. Referring to FIG. 1, the method 100 includes the following steps.

In step 101, the device acquires a plurality of sample images. The sample images may include predefined positive sample images and negative sample images. Each of the positive sample images contains at least one numeral character, and each of the negative sample images contains no numeral character or only partial numeral characters.

In step 102, the device generates a recognition model based on the sample images and a classification algorithm. For example, the device may perform training on the recognition model using the sample images and the classification algorithm.

In the method 100, by acquiring sample images including positive sample images and negative sample images and generating a recognition model using the sample images and a classification algorithm the recognition model may be capable to recognize positions of numerals having different font styles, font sizes, or numbers of digits.

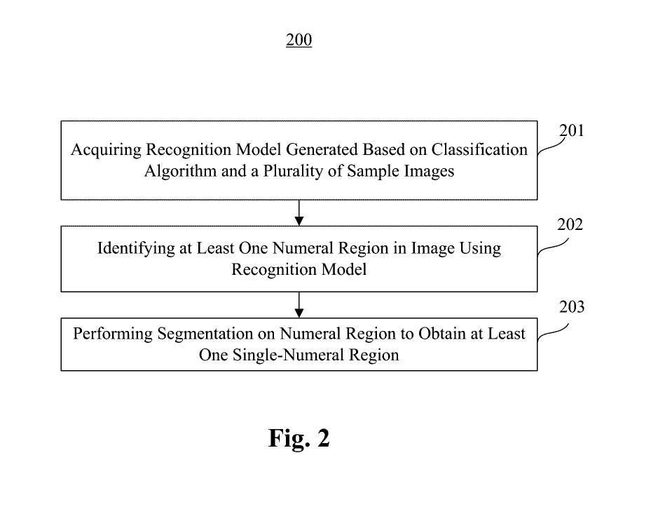

FIG. 2 is a flowchart of a method 200 for region recognition, according to an exemplary embodiment. The method 200 may be performed by a device such as a mobile phone, a computer, a digital broadcast terminal, a messaging device, a gaming console, a tablet, a medical device, exercise equipment, a personal digital assistant, and the like. Referring to FIG. 2, the method 200 includes the following steps.

In step 201, the device acquires a recognition model. The recognition model may be generated based on a plurality of sample images and a classification algorithm. The sample images may include predefined positive sample images and negative sample images. The positive sample images each contain at least one numeral character, and the negative sample images each contains no numeral character or only partial numeral characters.

In step 202, the device identifies at least one numeral region in an image using the recognition model.

In step 203, the device performs segmentation on the numeral region to obtain at least one single-numeral region.

In the method 200, by acquiring a recognition model, identifying at least one numeral region in an image using the recognition model, and performing segmentation on the numeral region to obtain at least one single-numeral region, numerals having different font styles, font sizes, or numbers of digits may be recognized.

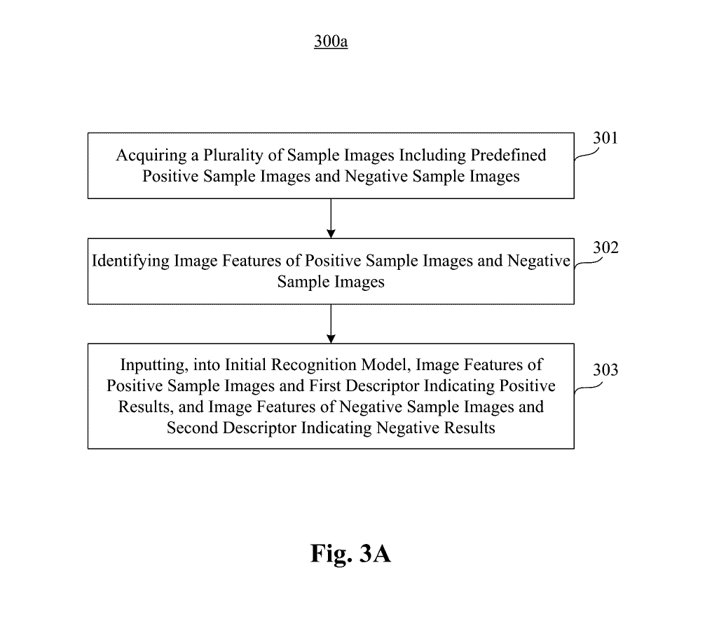

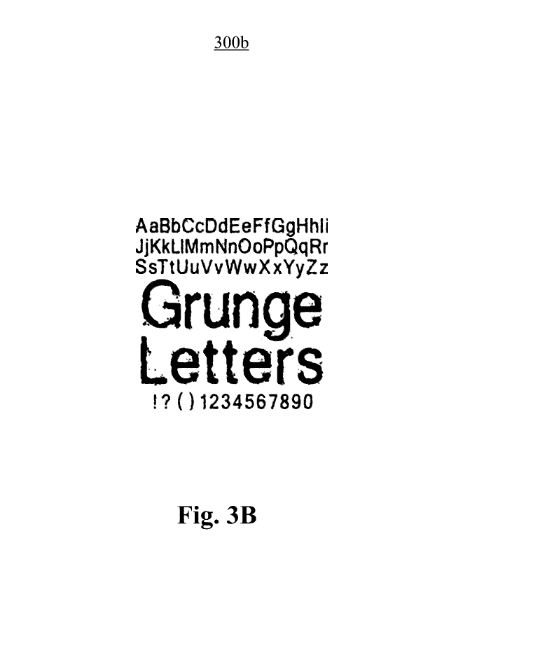

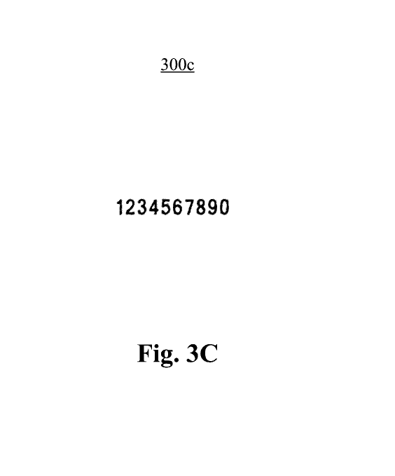

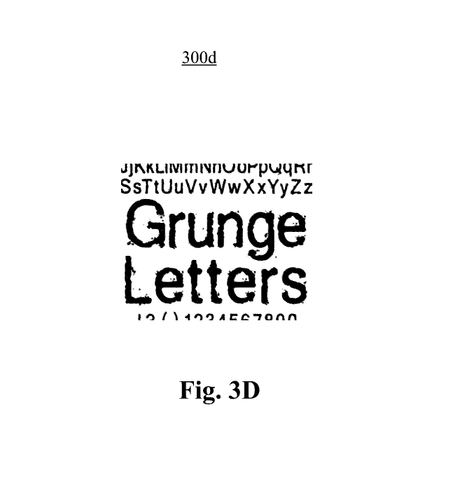

FIG. 3A is a flowchart of another method 300a for training a recognition model, according to an exemplary embodiment. The method 300a may be performed by a device such as a mobile phone, a computer, a digital broadcast terminal, a messaging device, a gaming console, a tablet, a medical device, exercise equipment, a personal digital assistant, and the like. Referring to FIG. 3A, the method 300a includes the following steps.

In step 301, the device acquires a plurality of sample images. The sample images may include predefined positive sample images and negative sample images. Each of the positive sample images contains at least one numeral character, and each of the negative sample images contains no numeral character or only partial numeral characters.

For example, the sample images may be selected from an image library or obtained by photographing. The sample images may include two types of images, i.e., positive sample images and negative sample images. A positive sample image may contain a single numeral character, or a single row of one or more numeral characters. The numeral characters in the positive sample images may not be limited to a particular font size, font style, or number of digits. The positive sample images may include one or more numeral images. A negative sample image may be an image containing no numeral character or partial numeral characters.

In some embodiments, a positive sample image may contain one or more numeral regions extracted from a same image. A negative sample image may contain one or more regions near the numeral regions in a same image or partial numerals extracted from the same image. FIG. 3B is a schematic diagram illustrating an original sample image 300b, according to an exemplary embodiment. FIG. 3C is a schematic diagram illustrating a positive sample image 300c, according to an exemplary embodiment. As shown in FIG. 3C, the positive sample image 300c is extracted from the original sample image 300b of FIG. 3B. FIG. 3D is a schematic diagram illustrating a negative sample image 300d, according to an exemplary embodiment. As shown in FIG. 3D, the negative sample image 300d is extracted from the original sample image 300b of FIG. 3B.

In step 302, the device identifies image features of the positive sample images and the negative sample images.

For example, the device may perform a feature recognition process on the positive sample images and the negative sample images separately, so as to obtain the image features of the positive sample images and the negative sample images.

In step 303, the device inputs, into an initial recognition model, the image features of the positive sample images and a first descriptor indicating positive results, and the image features of the negative sample images and a second descriptor indicating negative results. For example, the first descriptor indicating positive results may be set to 1, and the second descriptor indicating negative results may be set to −1. As a result, a recognition model is obtained by training the initial recognition model using the image features and descriptors of the sample images.

In some embodiments, the initial recognition model may be constructed by using a classification algorithm, such as an Adaboost, Support Vector Machine (SVM), Artificial Neural Network, Evolutionary Algorithm, Naive Bayes, Decision Trees, K-Nearest Neighbor (KNN), or the like.

For example, a sample image may include 256·256 pixels, a haar feature of the sample image may be identified, and the haar feature may be input into the initial model.

In the method 300a, by identifying image features of the positive sample images and the negative sample images and inputting the image features and descriptors indicating positive or negative results into an initial model, a recognition model that is capable to recognize numerals having different font styles, font sizes, or numbers of digits may be obtained.

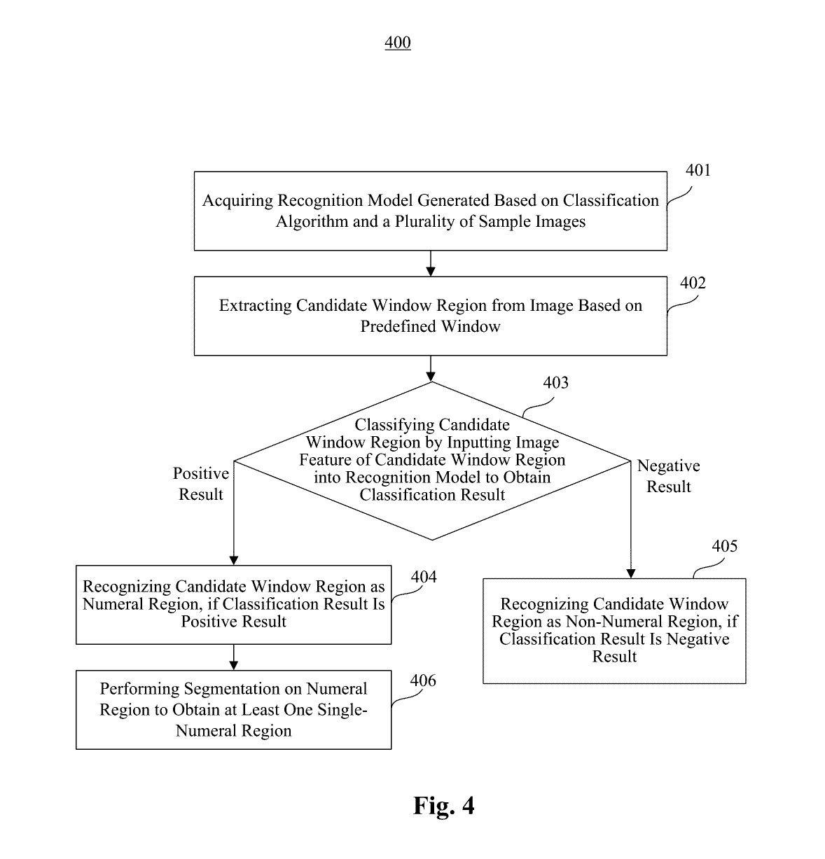

FIG. 4 is a flowchart of another method 400 for region recognition, according to an exemplary embodiment. The method 400 may be performed by a device such as a mobile phone, a computer, a digital broadcast terminal, a messaging device, a gaming console, a tablet, a medical device, exercise equipment, a personal digital assistant, and the like. Referring to FIG. 4, the method 400 includes the following steps.

In step 401, the device acquires a recognition model. The recognition model may be generated based on a plurality of sample images and a classification algorithm. For example, the device may perform training on the recognition model using the sample images and the classification algorithm. The sample images may include predefined positive sample images and negative sample images. Each of the positive sample images may contain at least one numeral character, and each of the negative sample images may contain no numeral character or only partial numeral characters.

In step 402, the device extracts a candidate window region from an image based on a predefined window.

For example, the device may progressively scan the image from left to right and top to bottom with the predefined window.

As another example, the device may scan the same image for multiple times with predefined windows of different sizes.

In some implementations, when the device scans the image by moving the predefined window, an overlapping in the positions of the predefined window may exist during movements of the predefined window.

For example, the predefined window may be set to have a size of 16·16 pixels, and the size of the image to be recognized may be 256·256 pixels. The device may begin scanning the image from an upper left right corner of the image, with the predefined window of 16·16 pixels. The device may scan pixels in the image from top to bottom and left to right. During the movement of the predefined window, an overlapping area may exist between two adjacent movements of the predefined window.

In step 403, the device classifies the candidate window region by inputting an image feature of the candidate window region into the recognition model to obtain a classification result. For example, a positive classification result may indicate that the candidate window region belongs to a class associated with the positive sample images, and a negative result may indicate that the candidate window region belongs to a class associated with negative sample images. As another example, if the classification result is positive, the candidate window region may be marked with the first descriptor representing the positive result in the recognition model, and if the classification result is negative, the candidate window region may be marked with the second descriptor representing the negative result in the recognition model.

For example, the device may identify an image feature of the candidate window region using a similar process as described in step 302 of FIG. 3A. The identified image feature of the candidate window region may be input into the recognition model, such as a recognition model acquired by performing method 300a shown in FIG. 3A. In some implementations, the recognition model may compare the image feature of the candidate window region with templates of the recognition model and determine whether the candidate window region is a numeral region.

In step 404, the device recognizes the candidate window region as a numeral region, if the classification result is a positive result.

In step 405, the device recognizes the candidate window region as a non-numeral region, if the classification result is a negative result.

In step 406, the device performs segmentation on the numeral region to obtain at least one single-numeral region.

For example, the device may perform segmentation on a candidate window region having a positive classification result, so as to obtain a single-numeral region within the candidate window region.

In the method 400, by extracting a candidate window region from the image to be recognized, classifying the candidate window region by inputting an image feature of the candidate window region into the recognition model, recognizing the candidate window region as a numeral region, and performing region segmentation on the numeral region, numerals having different font styles, font sizes, or numbers of digits may be recognized.

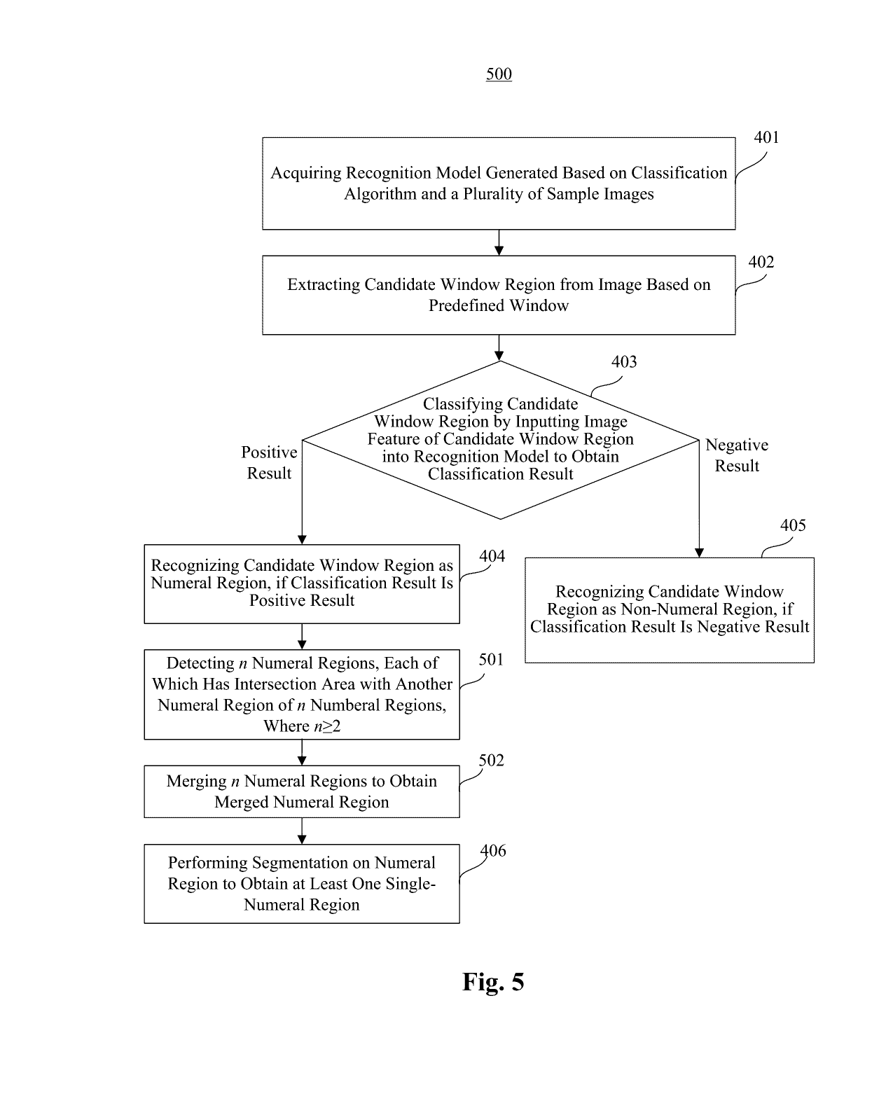

FIG. 5 is a flowchart of another method 500 for region recognition, according to an exemplary embodiment. The method 500 may be performed by a device such as a mobile phone, a computer, a digital broadcast terminal, a messaging device, a gaming console, a tablet, a medical device, exercise equipment, a personal digital assistant, and the like. In the method 500, the candidate window region includes at least two numeral regions, and the numeral regions may intersect with one another. Referring to FIG. 5, in addition to steps 401-406 (FIG. 4), the method 500 further includes the following steps after step 405.

In step 501, the device detects n numeral regions in the candidate window region, each of which has an intersection area with another numeral region of the n numeral regions, where n≧2.

For example, by identifying same numeral characters occurring in multiple numeral regions, a numeral region having an intersection area with another numeral region may be detected. As another example, a numeral region having an intersection area with another numeral region may be detected by identifying the numeral regions that contain the overlapping areas.

In step 502, the device merges the n numeral regions to obtain a merged numeral region.

In the method 500, by detecting overlapping numeral regions in a candidate window region and merging the overlapping numeral regions, the accuracy of numeral region recognition may be improved.

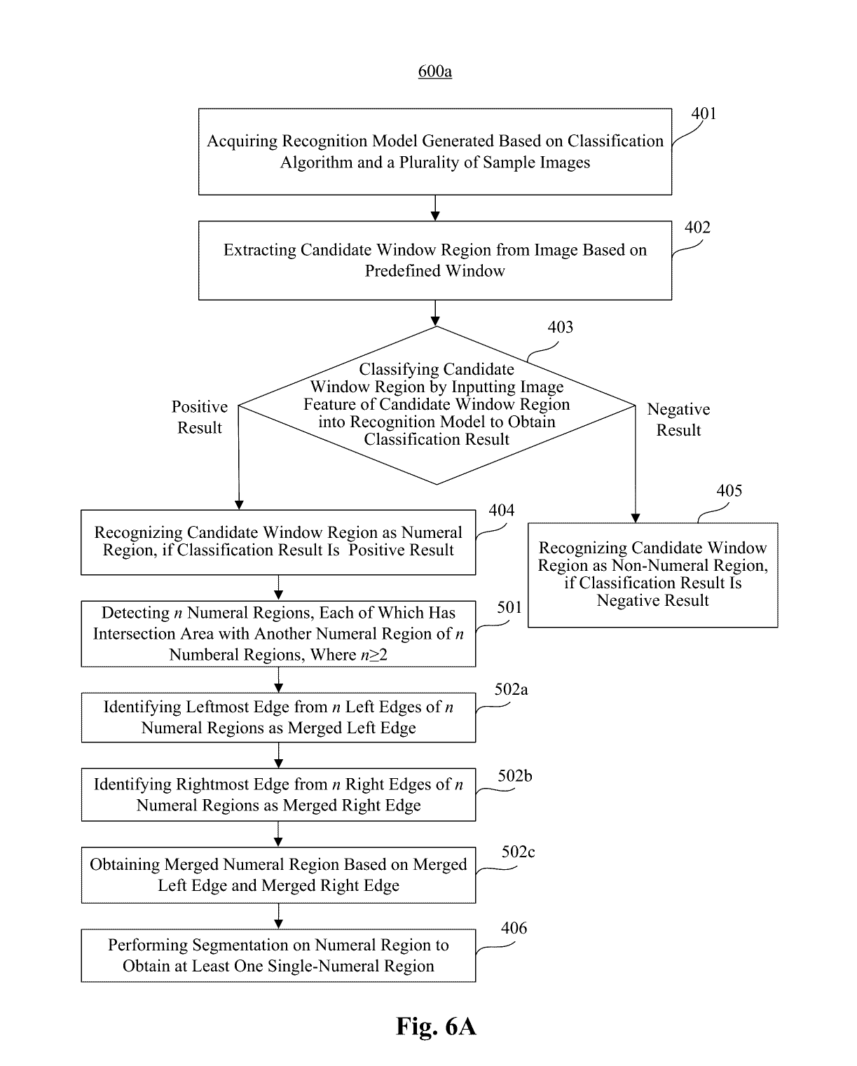

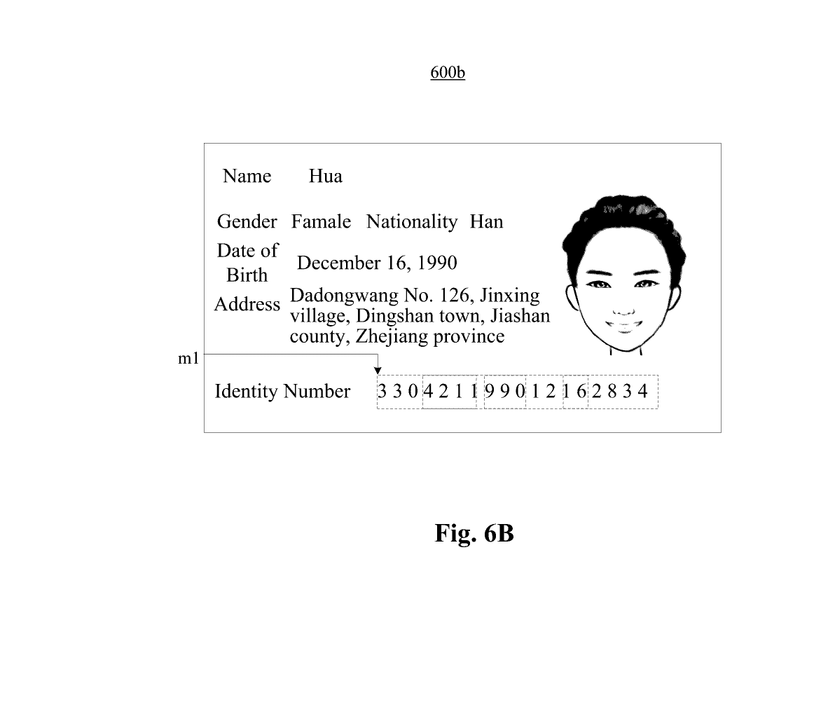

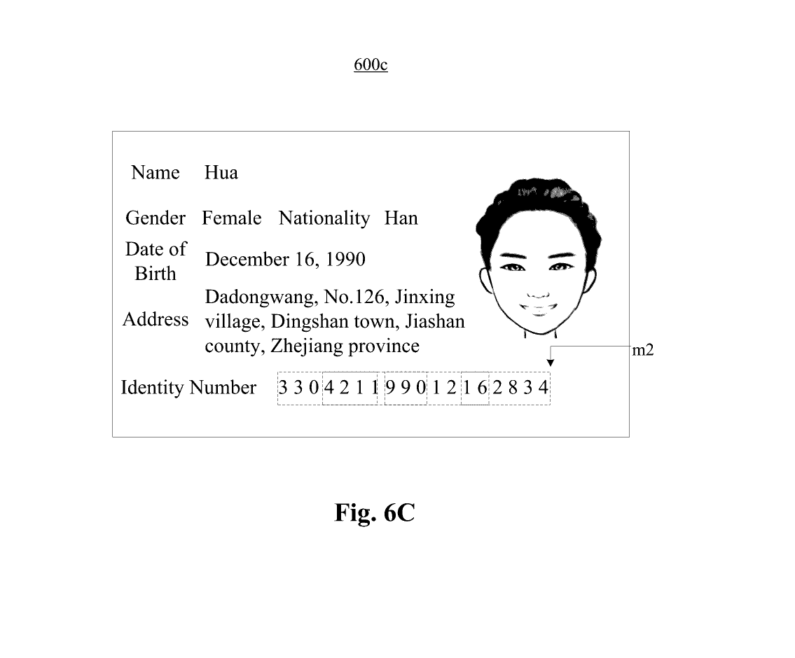

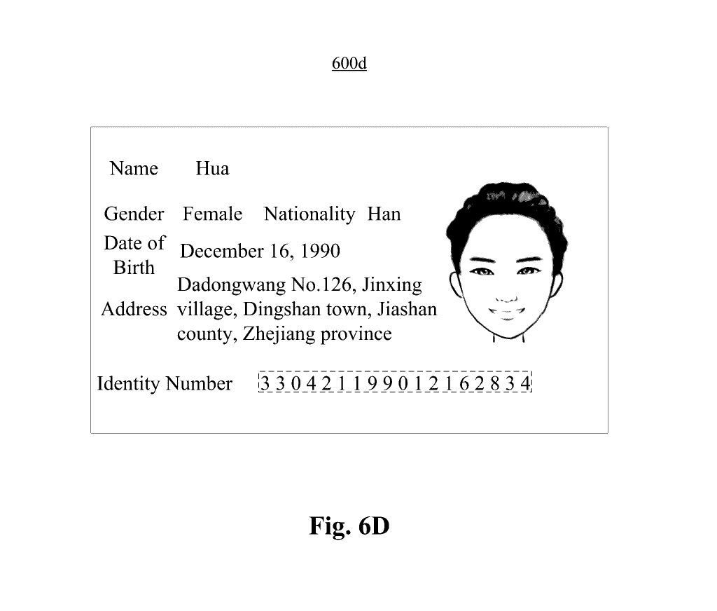

FIG. 6A is a flowchart of another method 600a for region recognition, according to an exemplary embodiment. The method 600a may be performed by a device such as a mobile phone, a computer, a digital broadcast terminal, a messaging device, a gaming console, a tablet, a medical device, exercise equipment, a personal digital assistant, and the like. Referring to FIG. 6A, step 502 of FIG. 5 may be implemented by steps 502a-502c in the method 600a, where the upper edges and lower edges of the n numeral regions may be in alignment.

In step 502a, the device identifies a leftmost edge from n left edges of the n numeral regions as a merged left edge.

FIG. 6B is a schematic diagram 600b illustrating a left edge of a merged numeral region, according to an exemplary embodiment. As shown in FIG. 6B, when the n numeral regions are arranged in a row, n left edges of the n numeral regions may be acquired, and the leftmost edge from n left edges of the n numeral regions is identified as the merged left edge m1.

In step 502b, the device identifies a rightmost edge from n right edges of the n numeral regions as a merged right edge.

FIG. 6C is a schematic diagram 600c illustrating a right edge of a merged numeral region, according to an exemplary embodiment. As shown in FIG. 6C, when the n numeral regions are arranged in a row, n right edges of the n numeral regions may be acquired, and the rightmost edge from n right edges of the n numeral regions is identified as the merged right edge m2.

In step 502c, the device obtains the merged numeral region based on the merged left edge and the merged right edge.

FIG. 6D is a schematic diagram 600d illustrating a merged numeral region, according to an exemplary embodiment. As shown in FIG. 6D, the merged numeral region is defined by the merged left edge, the merged right edge, and the aligned upper edge and lower edge of the n numeral regions.

In the method 600a, by identifying a leftmost edge from n left edges of the n numeral regions as a merged left edge, identifying a rightmost edge from n right edges of the n numeral regions as a merged right edge, a merged numeral region may be obtained, thereby improving the recognition accuracy of the numeral region.

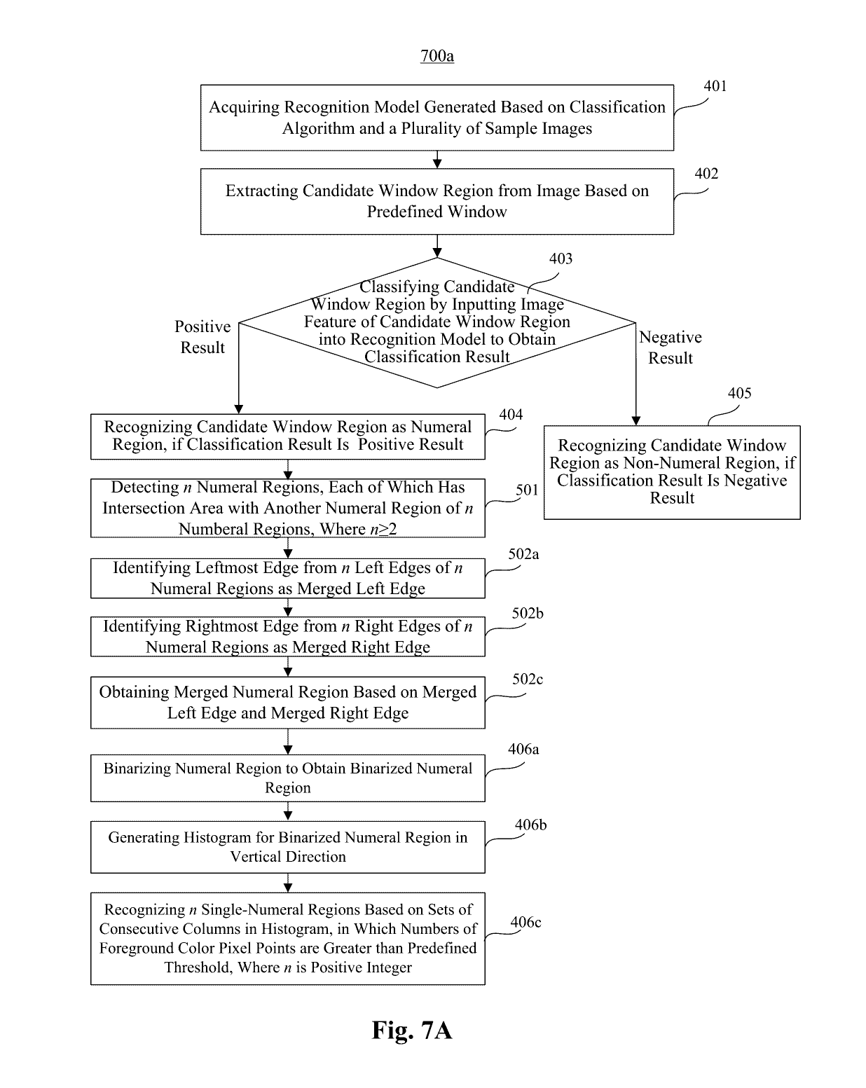

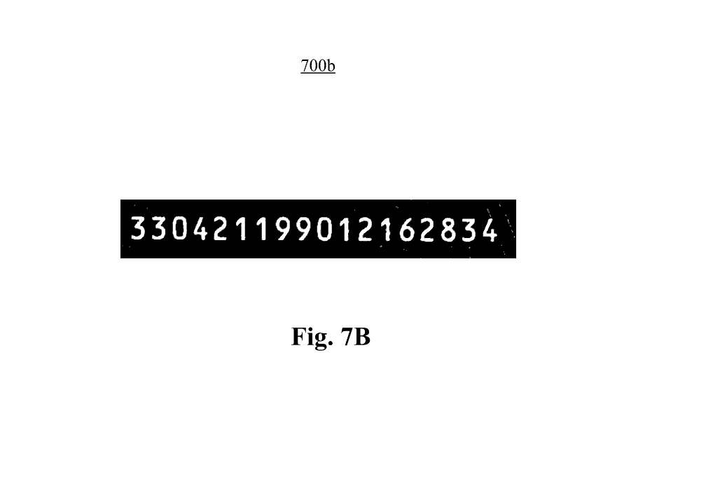

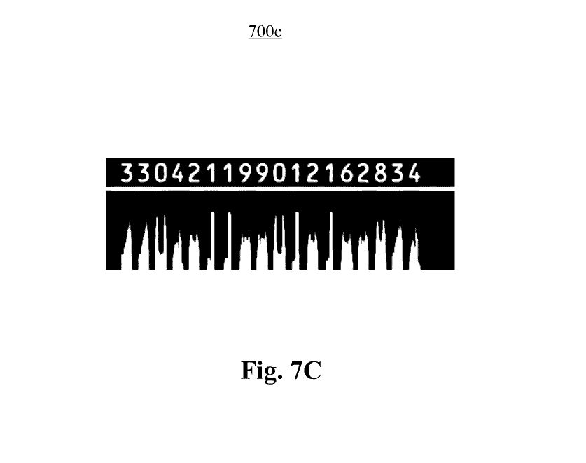

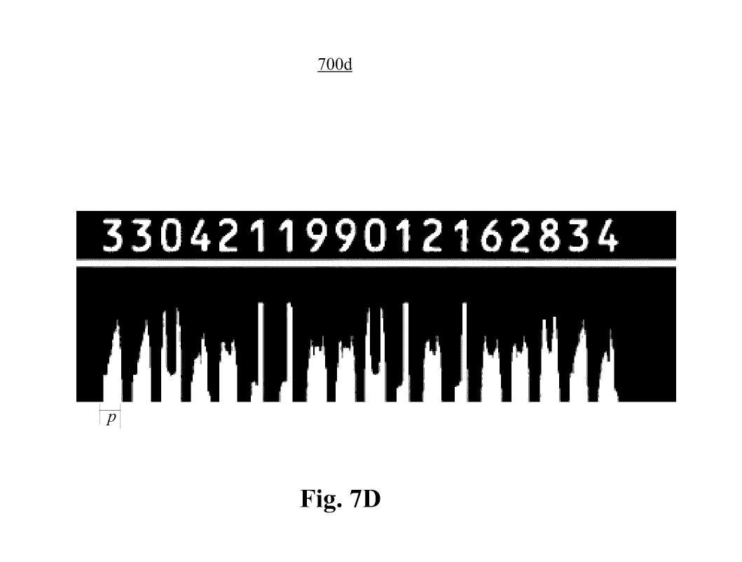

FIG. 7A is a flowchart of another method 700a for region recognition, according to an exemplary embodiment. The method 700a may be performed by a device such as a mobile phone, a computer, a digital broadcast terminal, a messaging device, a gaming console, a tablet, a medical device, exercise equipment, a personal digital assistant, and the like. Referring to FIG. 7A, step 406 of FIG. 6A may be implemented by steps 406a-406c in the method 700a.

In step 406a, the device binarizes the numeral region to obtain a binarized numeral region.

In some embodiments, before the binarization, the device may perform preprocessing on the numeral region, and the preprocessing may include operations such as denoising, filtering, boundary extraction, and so on. Subsequently, the preprocessed numeral region may be binarized.

For example, the device may compare gray-scale values of pixels within the numeral region with a predefined gray-scale threshold. The pixel points in the numeral region may be divided into two groups: a first group of pixels having gray-scale values greater than the predefined gray-scale threshold and a second group of pixels having gray-scale values lower than the predefined gray-scale threshold. The two groups of pixel points are presented with colors of black and white in the numeral region, thereby obtaining a binarized numeral region. FIG. 7B is a schematic diagram 700b illustrating a binarized region, according to an exemplary embodiment. As shown in FIG. 7B, the white pixel points are referred to as foreground color pixel points, and the black pixel points are referred to as background color pixel points.

In step 406b, the device generates a histogram for the binarized numeral region in the vertical direction. The histogram may include horizontal coordinates of pixel points in each column and the number of foreground color pixel points in each column.

FIG. 7C is a schematic diagram 700c illustrating a histogram of a binarized region, according to an exemplary embodiment. As shown in FIG. 7C, the horizontal axis of the histogram represents a horizontal coordinate of each column of pixel points, and the vertical axis of the histogram represents the number of foreground color pixel points in each column.

In step 406c, the device recognizes n single-numeral regions based on sets of consecutive columns in the histogram, in which the numbers of foreground color pixel points are greater than a predefined threshold, where n is a positive integer.

FIG. 7D is a schematic diagram 700d illustrating sets of consecutive columns of a binarized region, according to an exemplary embodiment. As shown in FIG. 7D, a set of consecutive columns, consists of p consecutive columns in which the numbers of foreground color pixel points are greater than the predefined threshold. This set of consecutive columns is represented by “p”, i.e., a consecutive white area formed in the histogram. The p consecutive columns of pixel points correspond to a numeral region of “3” in this example.

Each set of consecutive columns is recognized as a region of one numeral, and n sets of consecutive columns are recognized as n single-numeral regions.

In the method 700a, by binarizing the numeral region and generating a histogram for the binarized numeral region in the vertical direction the accuracy of recognizing the single-numeral regions in the numeral region may be improved.

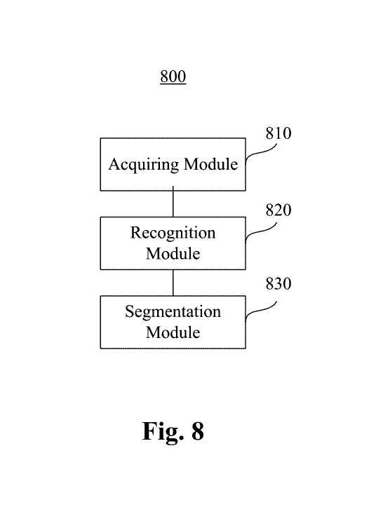

FIG. 8 is a block diagram of a device 800 for region recognition, according to an exemplary embodiment. Referring to FIG. 8, the device 800 includes an acquiring module 810, an recognition module 820, and a segmentation module 830.

The acquiring module 810 is configured to acquire a recognition model, where the recognition model may be trained based on sample images with a classification algorithm. The sample images includes predefined positive sample images and negative sample images, where each of the positive sample images contains at least one numeral character, and each of the negative sample images contains no numeral character or only partial numeral characters.

The recognition module 820 is configured to identify at least one numeral region of an image using the recognition model.

The segmentation module 830 is configured to perform segmentation on the numeral region to obtain at least one single-numeral region.

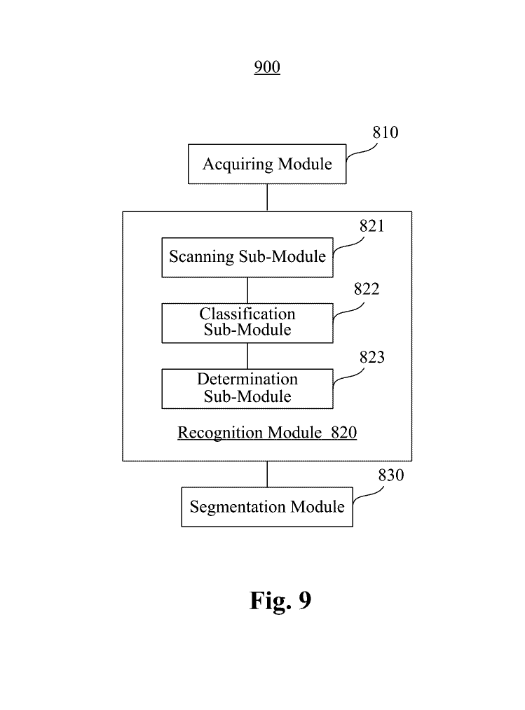

FIG. 9 is a block diagram of another device 900 for region recognition, according to an exemplary embodiment. Referring to FIG. 9, the device 900 includes the acquiring module 810, recognition module 820, and segmentation module 830, where the recognition module 820 includes a scanning sub-module 821, a classification sub-module 822, and a determination sub-module 823.

The scanning sub-module 821 is configured to extract a candidate window region from the image to be recognized based on a predefined window.

For example, a predefined window of a fixed size may be set by the scanning sub-module 821. By using the predefined window, the scanning sub-module 821 may progressively scan the image according to a predetermined scanning mechanism to extract multiple candidate window regions from the image.

The classification sub-module 822 is configured to classify the candidate window region by inputting an image feature of the candidate window region into the recognition model to obtain a classification result.

For example, the classification sub-module 822 may identify an image feature of the candidate window region obtained by the scanning sub-module 821. The candidate window region is classified by inputting an image feature of the candidate window region into the recognition model acquired in the acquiring module 810. In some implementations, the classification sub-module 822 may compare the image feature extracted from a candidate window region with templates of the recognition model and determine whether the candidate window region is a numeral region. For example, a positive classification result may indicate that the candidate window region belongs to a class associated with a positive sample image, and a negative result may indicate that the candidate window region belongs to a class associated with a negative sample image.

The determination sub-module 823 is configured to recognize the candidate window region as a numeral region, if the classification result is a positive result, and to recognize the candidate window region as a non-numeral region, if the classification result is a negative result.

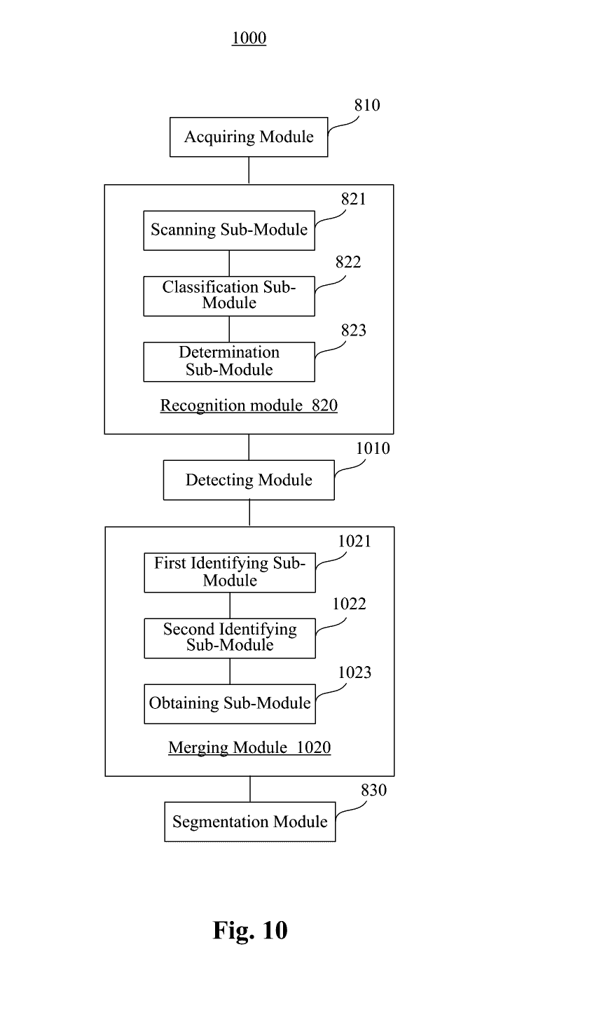

FIG. 10 is a block diagram of another device 1000 for region recognition, according to an exemplary embodiment. Referring to FIG. 10, in addition to the acquiring module 810, recognition module 820, and segmentation module 830, the device 1000 further includes to detecting module 1010 and a merging module 1020.

The detecting module 1010 is configured to detect n numeral regions each of which has an intersection area with another numeral region, where n≧2.

The merging module 1020 is configured to merge the n numeral regions to obtain a merged numeral region.

As shown in FIG. 10, the merging module 1020 may include a first identifying sub-module 1021, a second identifying sub-module 1022, and an obtaining sub-module 1023.

The first identifying sub-module 1021 may be configured to identify a leftmost edge from n left edges of the n numeral regions as a merged left edge, where upper edges and lower edges of the n numeral regions are in alignment respectively.

The second identifying sub-module 1022 may be configured to identify a rightmost edge from n right edges of the n numeral regions as a merged right edge.

The obtaining sub-module 1023 may be configured to obtain the merged numeral region based on the merged left edge identified by the first identifying sub-module 1021 and the merged right edge identified by the second identifying sub-module 1022, where upper edges and lower edges of the n numeral regions may be in alignment.

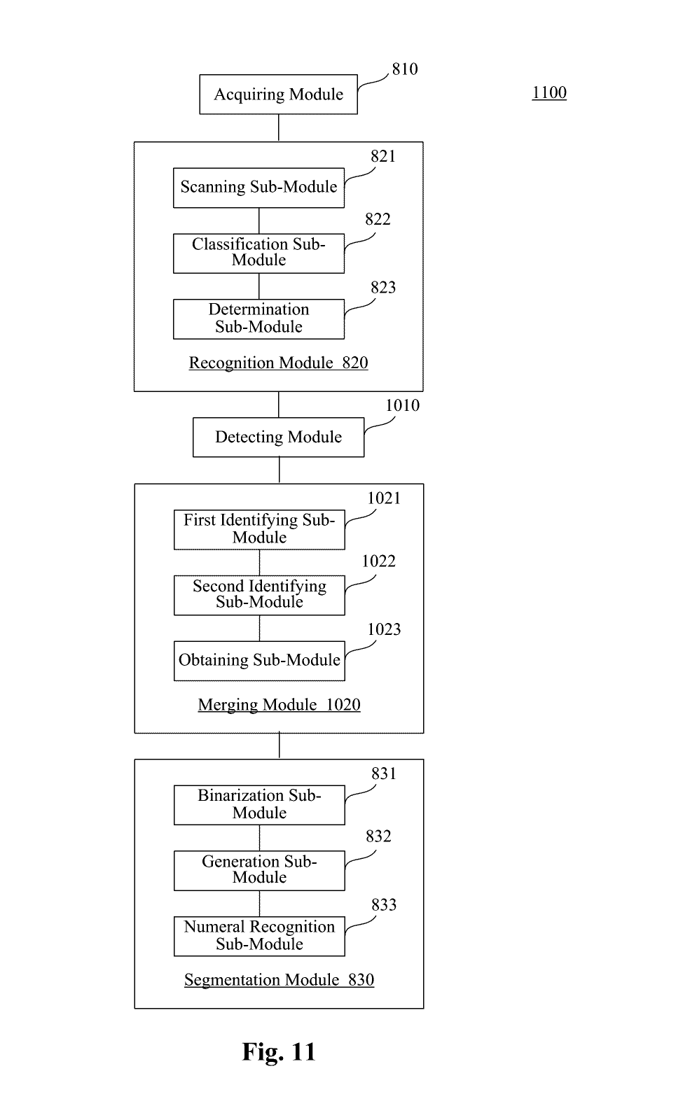

FIG. 11 is a block diagram of another device 1100 for region recognition, according to an exemplary embodiment. Referring to FIG. 11, the segmentation module 830 includes a binarization sub-module 831, a generation sub-module 832, and a numeral recognition sub-module 833.

The binarization sub-module 831 is configured to perform binarization on the numeral region to obtain a binarized numeral region.

In some embodiments, the binarization sub-module 831 may be configured to perform preprocessing on the numeral region, and the preprocessing may include operations such as denoising, filtering, boundary extraction, etc. Subsequently, the preprocessed numeral region may be binarized.

The generation sub-module 832 is configured to generate a histogram for the binarized numeral region in the vertical direction. The histogram may include horizontal coordinates of pixel points in each column and the number of foreground color pixel points in each column.

The numeral recognition sub-module 833 is configured to recognize n single-numeral based on sets of consecutive columns in the histogram, in which the numbers of foreground color pixel points are greater than a predefined threshold, where n is a positive integer. Each set of consecutive columns is recognized as a region of one numeral, and n consecutive column sets are recognized as n single-numeral regions.

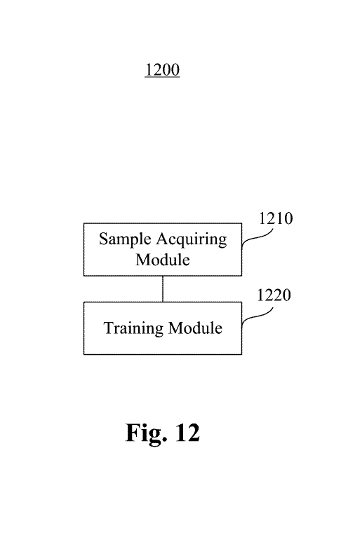

FIG. 12 is a block diagram of a device 1200 for training a recognition model, according to an exemplary embodiment. Referring to FIG. 12, the device 1200 includes a sample acquiring module 1210 and a training module 1220.

The sample acquiring module 1210 is configured to acquire sample images. The sample images include predefined positive sample images and negative sample images, where each of the positive sample images contains at least one numeral character, and each of the negative sample images contains no numeral character or only partial numeral characters.

The training module 1220 is configured to generate a recognition model based on the sample images and a classification algorithm. For example, the training module 1220 may perform training on the recognition model using the sample images and the classification algorithm.

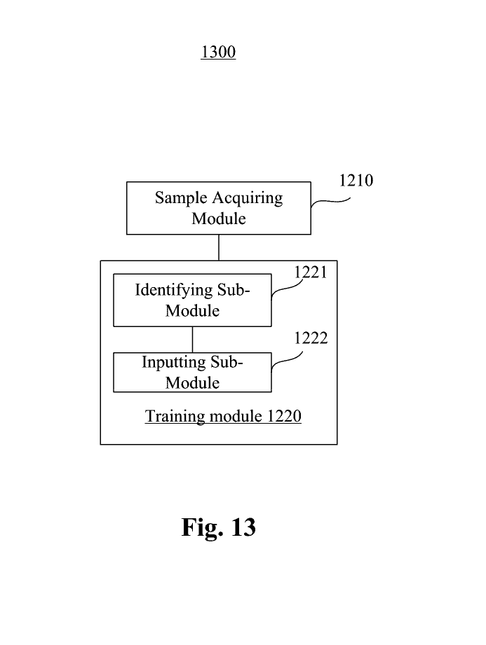

FIG. 13 is a block diagram of another device 1300 for training a recognition model, according to another exemplary embodiment. Referring to FIG. 13, the training module 1220 includes an identifying sub-module 1221 and an inputting sub-module 1222.

The identifying sub-module 1221 is configured to identify image features of the positive sample images and the negative sample images.

After the positive sample images and the negative sample images are acquired by the sample acquiring module 1210, a process of feature recognition has been performed by the identifying sub-module 1221 for the positive sample images and the negative sample images respectively, so as to obtain the image features of the positive sample images and the negative sample images.

The inputting sub-module 1222 is configured to input, into an initial recognition model, the image features of the positive sample images and a first descriptor indicating positive results, and the image features of the negative sample images and a second descriptor indicating negative results, so as to obtain the recognition model. The initial recognition model may be constructed by using a classification algorithm, such as an Adaboost, SVM, Artificial Neural Network, Evolutionary Algorithm, Naive Bayes, Decision Trees, KNN, or the like.

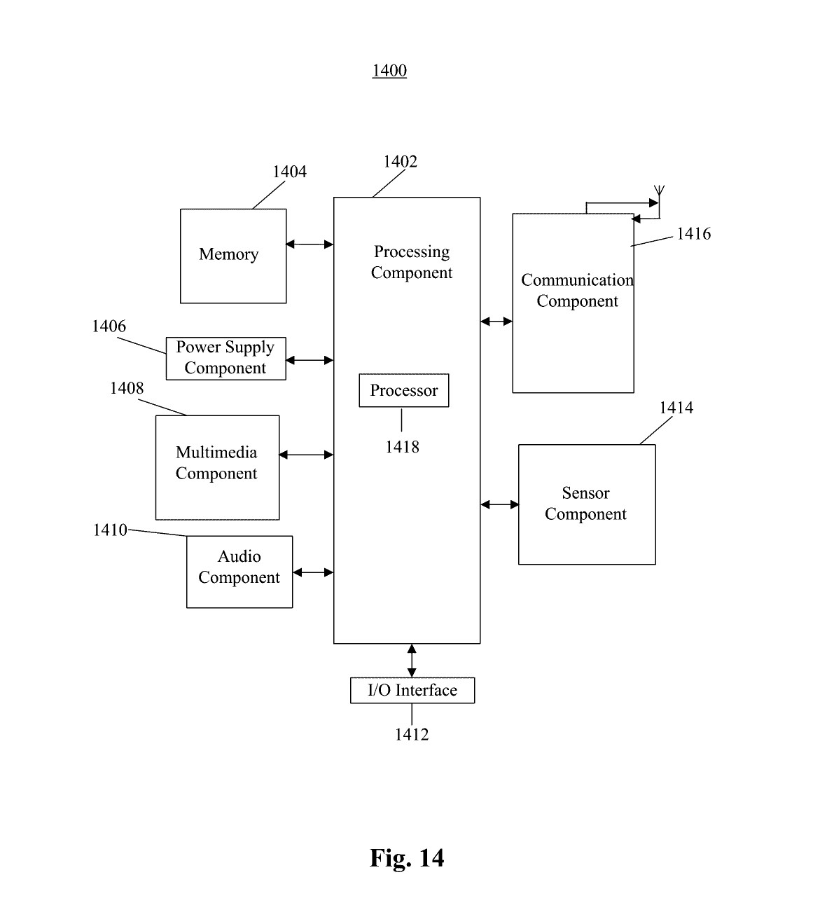

FIG. 14 is a block diagram of a device 1400 for region recognition, according to an exemplary embodiment. For example, the device 1400 may be a mobile phone, a computer, a digital broadcast terminal, a messaging device, a gaming console, a tablet, a medical device, exercise equipment, a personal digital assistant, and the like.

Referring to FIG. 14, the device 1400 may include one or more of the following components: a processing component 1402, a memory 1404, a power supply component 1406, a multimedia component 1408, an audio component 1410, an input/output (I/O) interface 1412, a sensor component 1414, and a communication component 1416. The person skilled in the art should appreciate that the structure of the device 1400 as shown in FIG. 14 does not intend to limit the device 1400. The device 1400 may include more or less components or combine some components or other different components.

The processing component 1402 typically controls overall operations of the device 1400, such as the operations associated with display, telephone calls, data communications, camera operations, and recording operations. The processing component 1402 may include one or more processors 1418 to execute instructions to perform all or part of the steps in the above described methods. Moreover, the processing component 1402 may include one or more modules which facilitate the interaction between the processing component 1402 and other components. For instance, the processing component 1402 may include a multimedia module to facilitate the interaction between the multimedia component 1408 and the processing component 1402.

The memory 1404 is configured to store various types of data to support the operation of the device 1400. Examples of such data include instructions for any applications or methods operated on the device 1400, contact data, phonebook data, messages, images, video, etc. The memory 1404 is also configured to store programs and modules. The processing component 1402 performs various functions and data processing by operating programs and modules stored in the memory 1404. The memory 1404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1406 is configured to provide power to various components of the device 1400. The power supply component 1406 may include a power management system, one or more power sources, and any other components associated with the generation, management, and distribution of power in the device 1400.

The multimedia component 1408 includes a screen providing an output interface between the device 1400 and a user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1408 includes a front camera and/or a rear camera. The front camera and the rear camera may receive an external multimedia datum while the device 1400 is in an operation mode, such as a photographing mode or a video mode. Each of the front camera and the rear camera may be a fixed optical lens system or have focus and optical zoom capability.

The audio component 1410 is configured to output and/or input audio signals. For example, the audio component 1410 includes a microphone configured to receive an external audio signal when the device 1400 is in an operation mode, such as a call mode, a recording mode, and a voice recognition mode. The received audio signal may be further stored in the memory 1404 or transmitted via the communication component 1416. In some embodiments, the audio component 1410 further includes a speaker to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a locking button.

The sensor component 1414 includes one or more sensors to provide status assessments of various aspects of the device 1400. For instance, the sensor component 1414 may detect an on/off state of the device 1400, relative positioning of components, e.g., the display and the keypad, of the device 1400, a change in position of the device 1400 or a component of the device 1400, a presence or absence of user contact with the device 1400, an orientation or an acceleration/deceleration of the device 1400, and a change in temperature of the device 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments, the sensor component 1414 may also include an accelerometer sensor, a gyroscope sensor, a magnetic sensor, a pressure sensor, or a temperature sensor.

The communication component 1416 is configured to facilitate communication, wired or wirelessly, between the device 1400 and other devices. The device 1400 can access a wireless network based on a communication standard, such as WiFi, 2G; or 3G; or a combination thereof. In one exemplary embodiment, the communication component 1416 receives a broadcast signal or broadcast information from an external broadcast management system via a broadcast channel. In one exemplary embodiment, the communication component 1416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1404, executable by the processor 1418 in the device 1400, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art that the above described modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. The specification and embodiments are merely considered to be exemplary and the substantive scope and spirit of the disclosure is limited only by the appended claims.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a device to perform region recognition, comprising:
acquiring a recognition model, the recognition model being generated based on a plurality of sample images and a classification algorithm, wherein the sample images include predefined positive sample images and negative sample images, each of the positive sample images contains at least one numeral character, and each of the negative sample images contains no numeral character or a partial numeral character;
identifying at least one numeral region in an image using the recognition model; and
performing segmentation on the numeral region to obtain at least one single-numeral region.

2. The method of claim 1, wherein identifying the numeral region comprises:
extracting a candidate window region from the image based on a predefined window;
classifying the candidate window region by inputting an image feature of the candidate window region into the recognition model to obtain a classification result; and
recognizing the candidate window region as the numeral region, if the classification result is a positive result indicating the candidate window region belongs to a class associated with the positive sample images.

3. The method of claim 2, further comprising:
detecting n numeral regions, each of the n numeral regions having an intersection area with another numeral region of the n numeral regions, wherein n≧2; and
merging the n numeral regions to obtain a merged numeral region.

4. The method of claim 3, wherein upper edges of the n numeral regions are in alignment, and lower edges of the n numeral regions are in alignment, and wherein the merging comprises:
identifying a leftmost edge from n left edges of the n numeral regions as a merged left edge;
identifying a rightmost edge from n right edges of the n numeral regions as a merged right edge; and
obtaining the merged numeral region based on the merged left edge and the merged right edge.

5. The method of claim 1, wherein the segmentation comprises:
binarizing the numeral region to obtain a binarized numeral region;
generating a histogram for the binarized numeral region in a vertical direction, the histogram including horizontal coordinates of pixel points in each column and a number of foreground color pixel points in each column; and
recognizing n single-numeral regions based on one or more sets of consecutive columns in the histogram, wherein the number of foreground color pixel points in each column of the consecutive columns is greater than a predefined threshold, and n is a positive integer.

6. The method of claim 5, further comprising:
performing preprocessing on the numeral region before the binarizing.

7. The method of claim 1, wherein acquiring the recognition model comprises:
identifying image features of the positive sample images and the negative sample images; and
training an initial recognition model based on the image features of the positive sample images and a first descriptor indicating a positive result, and the image features of the negative sample images and a second descriptor indicating a negative result.

8. The method of claim 1, wherein one of the positive sample images includes one or more numeral regions extracted from a same image.

9. The method of claim 1, wherein the classification algorithm comprises at least one of Adaboost, Support Vector Machine (SVM), Artificial Neural Network, Evolutionary Algorithm, Naive Bayes, Decision Trees, and K-Nearest Neighbor.

10. A device for region recognition, comprising:
a processor; and
a memory for storing instructions executable by the processor;
wherein the processor is configured to:
acquire a recognition model, the recognition model being generated based on a plurality of sample images and a classification algorithm, wherein the sample images include predefined positive sample images and negative sample images, each of the positive sample images contains at least one numeral character, and each of the negative sample images contains no numeral character or a partial numeral characters;
identify at least one numeral region in an image using the recognition model; and
perform segmentation on the numeral region to obtain at least one single-numeral region.

11. The device of claim 10, wherein the processor is further configured to:
extract a candidate window region from the image based on a predefined window;
classify the candidate window region by inputting an image feature of the candidate window region into the recognition model to obtain a classification result; and
recognize the candidate window region as the numeral region, if the classification result is a positive result indicating the candidate window region belongs to a class associated with the positive sample images.

12. The device of claim 11, wherein the processor is further configured to:
detect n numeral regions, each of the n numeral regions having an intersection area with another numeral region of the n numeral regions, wherein n≧2; and
merge the n numeral regions to obtain a merged numeral region.

13. The device of claim 12, wherein upper edges of the n numeral regions are in alignment, and lower edges of the n numeral regions are in alignment, and wherein the processor is further configured to:
identify a leftmost edge from n left edges of the n numeral regions as a merged left edge;
identify a rightmost edge from n right edges of the n numeral regions as a merged right edge; and
obtain the merged numeral region based on the merged left edge and the merged right edge.

14. The device of claim 10, wherein the processor is further configured to:
binarize the numeral region to obtain a binarized numeral region;
generate a histogram for the binarized numeral region in a vertical direction, the histogram including horizontal coordinates of pixel points in each column and a number of foreground color pixel points in each column; and
recognize n single-numeral regions based on one or more sets of consecutive columns in the histogram, wherein the number of foreground color pixel points in each column of the consecutive columns is greater than a predefined threshold, and n is a positive integer.

15. The device of claim 14, wherein the processor is further configured to:
perform preprocessing on the numeral region before the binarizing

16. The device of claim 10, wherein the processor is further configured to:
identify image features of the positive sample images and the negative sample images; and
train an initial recognition model based on the image features of the positive sample images and a first descriptor indicating a positive result, and the image features of the negative sample images and a second descriptor indicating a negative result.

17. The device of claim 10, wherein one of the positive sample images includes one or more numeral regions extracted from a same image.

18. The device of claim 10, wherein the classification algorithm comprises at least one of Adaboost, Support Vector Machine (SVM), Artificial Neural Network, Evolutionary Algorithm, Naive Bayes, Decision Trees, and K-Nearest Neighbor.

19. A non-transitory computer-readable storage medium having stored therein instructions that, when executed by a processor of a device, cause the device to perform the method of claim 1.
